(19) United States
(12) Patent Application Publication
(10) Pub. No.: US 2010/0054752 A1
(43) Pub. Date: Mar. 4, 2010

(54) OPTICAL MODULE

(76) Inventors: Ryosuke Kuribayashi, Minato-ku (JP); Ichiro Ogura, Minato-ku (JP); Masahiro Arai, Minato-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 12/530,452

(22) PCT Filed: Mar. 5, 2008
(86) PCT No.: PCT/JP2008/053939

§ 371 Date: Sep. 8, 2009

(30) Foreign Application Priority Data
Mar. 5, 2007 (JP) 2007-054379

(51) Int. Cl. H04B 10/00; G06F 12/00; H04Q 5/22

(52) U.S. Cl. 398/140; 711/103; 340/10.51; 711/E12.001; 711/E12.008

(57) ABSTRACT

An optical module comprises: a photoelectric conversion device; at least one of a transmitter LSI and a receiver LSI; one or more memory devices; and an input/output terminal to read and write stored information within the memory device(s). The memory device(s) further comprises: a first memory region where a predetermined driving condition for the optical module or manufacturing information and other basic data inherent to the optical module, or a driving condition or its correction factor table is recorded before shipment as an optimum driving condition for the optical module when installed in a system; and a second memory region where history information such as accumulated use time is recorded after the shipment.

### TECHNICAL FIELD

### Reference to Related Application

The present invention is based upon and claims the benefit of the priority of Japanese patent application No. 2007-054379, filed on Mar. 5, 2007, the disclosure of which is incorporated herein in its entirety by reference thereto.

The present invention relates to an optical module, and more specifically to an optical module that is used in optical interconnection and has improved handling ease, and simple exchangeability and reparability (namely exchanged and repaired with less effort when in trouble).

### BACKGROUND ART

Research and development have been actively done on optical interconnection which replaces a high speed interconnection between devices or within a device like a computer, server, router, storage and others realized conventionally by an electric wire with an optical wiring.

To realize a transmission rate not less than 10 Gbps in an electric wire, there arises a problem that a transmittable distance is limited to several centimeters to several ten centimeters and total power consumption generally increases because a waveform shaping circuit is required.

When total transmission capacity is increased using parallel signal lines, there arises an implementation related problem of increasing number of pins for the signal lines, increasing area occupied by the transmission lines, and increasing cross section area of the cable.

These problems hinder the development of information and communication equipment in the future.

A reason for the active research and development of optical interconnection is that it is expected that it will overcome these problems.

A demand on an optical module used in the optical interconnection is different from that used in a backbone communication system.

Since an optical module used in the optical interconnection is implemented (mounted) with other electronic circuits on a board (electronic circuit board), its mounting area, heat generation and price etc., constitute especially important factors. Demand for miniaturization, low power consumption, and low price of an optical module used in the optical interconnection is higher than that of an optical module used in a backbone communication system. For example, the size of a small optical module used in the optical interconnection (small optical I/O, Optical Sub-Assembly (OSA) and others) is preferably not greater than ten and several millimeters square, likewise as the case with general LSIs.

Each optical module from its development phase to an initial phase of its mass production has a different optimal driving condition due to variation in device characteristics, implementation or assembly, or difference in accumulated use time.

Each small optical module used in optical interconnection has a different operation environment within a system to which the module is applied (implementation condition, electrical connection to other devices, length and characteristics of electrical transmission lines, temperature (cooling and heat dissipation environment), length and characteristics of optical transmission lines) and different required performances (transmission rate, reliability of quality, power consumption and others). Therefore, each module generally has a different optimal driving condition according to these operation environment and required performance.

For example, Patent Document 1 describes, as an example of an optical module with a memory device that stores a driving condition, a laser diode array assembly that includes a laser diode array and a monolithic memory device that stores operation information for the laser diode array. Patent Document 2 describes a self-luminous optical module that includes: a plurality of self-luminous devices; a memory that stores data for adjusting luminance of the self-luminous devices; and a drive unit that generates driving current for adjusting luminance of each self-luminous optical device based on the data stored in the memory. Patent Document 3 describes a laser module wherein a laser chip and a memory device are mounted in a package other than a laser control system and the memory device stores necessary operation parameters for the laser chip.

### [Patent Document 1]

JP Patent Kokai Publication No. JP-P2001-203418A

### [Patent Document 2]

JP Patent Kokai Publication No. JP-P2004-354684A

### [Patent Document 3]

JP Patent Kokai Publication No. JP-P2001-196690A

### DISCLOSURE OF THE INVENTION

### Problems to be Solved by the Invention

The disclosures of Patent Documents 1 to 3 in the above are incorporated herein by reference thereto. The following analysis on the related art is given by the present invention. A conventional transceiver LSI within a small optical module with a size of ten and several millimeters square does not have a memory device that stores information inherent to the module and output it at the startup.

The conventional transceiver LSI cannot optimize its driving condition by itself when it is implemented to a system. Each user must obtain or derive an optimal driving condition for each optical module implemented to an individual system and manage it.

As shown in FIG. 1A and FIG. 2, it is necessary to provide a user with a conventional optical module as a board 5 that includes: a microcomputer 4a with a nonvolatile memory device 3 such as a ROM (Read Only Memory) etc.; and its peripheral circuits 9, in addition to an optical module 1 (Patent Documents 1, 2). The microcomputer 4a may be an ASIC or FPGA (Field Programmable Gate Array) and other processing devices. A device or circuit included in the peripheral circuits 9 is, for example, a buffering IC, resistor, capacitor, or feedback loop circuit for optimizing operation of the optical module.

When an optical module 1 is provided without a nonvolatile memory device 3, it is necessary to provide a user with driving condition data (document data or electronic data) 6, as a separate attachment from the optical module 1 as shown in FIG. 1B.

In the former case (FIGS. 1A and 2), a user is always provided with the optical module 1 as a board 5 that includes a set of a microcomputer 4a and its peripheral circuits 9. Therefore, the size is twice or more of the small optical module itself and there arises a problem that freedom of layout design for a system that has the optical module 1 is restricted.

In the latter case (FIG. 1B), there arises a problem that it takes time to write driving condition data 6 into an optical module 1 not only when a system with the optical module 1 is built but also every time the optical module 1 is started, and it takes time to replace the optical module 1 and recover from the failure when it breaks down.

There is also a problem that it is physically impossible to install all of a microcomputer 4a with a nonvolatile memory device 3 and its peripheral circuits 9 within a small optical module 1 whose size is not greater than ten and several millimeters square.

Therefore, it is an object of the present invention to provide an ultrasmall (at most ten and several millimeters square) optical module having information to optimize driving conditions in any user system (basic data inherent to the optical module that is recorded at shipment (basic driving condition, driving condition according to an operation environment, its correction factor table and others) and use history information that varies in time (accumulated use time and others)) with excellent ease at handling, exchangeability and reparability.

### Means to Solve the Problems

According to a first aspect of the present invention, there is provided an optical module comprising:

a photoelectric conversion device;

at least one of a transmitter LSI and a receiver LSI;

one or more memory devices; and

an input/output terminal to read and write stored information within the memory device(s); wherein the memory device(s) further comprises: a first memory region where a predetermined driving condition for the optical module or manufacturing information and other basic data inherent to the optical module, or a driving condition or its correction factor table is recorded before shipment as an optimum driving condition for the optical module when installed in a system; and a second memory region where history information such as accumulated use time is recorded after the shipment.

In the above optical module, at least one of the memory device(s) may be a nonvolatile memory device.

In the above optical module, the nonvolatile memory device may be a mask ROM.

In the above optical module, the nonvolatile memory device may be a PROM (Programmable ROM).

In the above optical module, the PROM may be an EEPROM (Electrically Erasable PROM).

In the above optical module, the PROM may be an RFID (Radio Frequency ID) or an RF tag.

According to a second aspect of the present invention, there is provided an optical module comprising one or more memory devices, wherein the memory device(s) further comprises:

a first memory region where basic data inherent to the optical module is recorded before shipment; and

a second memory region where history information of the optical module is recorded after the shipment.

According to a third aspect of the present invention, there is provided an optical module comprising: one or more memory devices, wherein the memory device(s) further comprises:

a first memory region where a driving condition inherent to the optical module or its correction factor table is recorded before shipment; and

a second memory region where history information of the optical module is recorded after the shipment.

In the above optical module, the memory device(s) is preferably a nonvolatile memory device.

In the above optical module, the history information preferably includes accumulated use time of the optical module.

### MERITORIOUS EFFECTS OF THE INVENTION

According to the present invention, there is provided an ultrasmall optical module with improved ease in handling, exchangeability and reparability, while keeping its size, which is counted as a first effect.

It is possible to provide users with an optical module which is in an ultrasmall package without a processing element like a microcomputer and its peripheral circuits and without attaching document data on driving conditions and others. Therefore, the optical module is easy for users to handle.

Particularly, when it breaks down, replacing an optical module by replacement of the driving condition and other information takes place at the same time, too. Therefore, it is not necessary for users to record the information into the optical module or the like.

As a second effect, the module structure of the present invention makes it easy to optimize (or improve) performance of a small optical module in a system, which leads to longer lifetime and improved reliability of the module.

In other words, by optimally driving a module in each system, performance can be totalized at its maximum. A useless operation beyond the system requirement such as excessive output power can also be prevented. Furthermore, correcting a condition according to aging degradation makes it possible to prevent the performance from degradation for a longer period of time.

Further, from a vendor's point of view, guaranteeing (storing in a memory device) a standard driving condition and performance (basic data) before shipment may alone meet wide variety of user needs/system requirement, which easily leads to mass production and generalization by suppressing a particular specification.

As a third effect, the module structure according to the present invention makes it easy to manage and control multiple optical modules.

In a case where each optical module 101 itself doesn't possess data, data for the many optical modules 101 must be stored and processed at one spot (single CPU, microcomputer, ASIC, FPGA and others) in order to manage and control multiple optical modules. However, since each optical module 101 according to the present invention possesses basic data inherent to it in the nonvolatile memory device, a load on a device that performs the cumulative management and control can be reduced.

By employing, for example, as the nonvolatile memory device, a serial EEPROM that contains a serial interface (for example, I2C, SPI (Serial Peripheral Interface)) whose total number of signal pins is less than that for a microcomputer, an area for electrical signal wires to read from and write to an optical module can be reduced.

Particularly, when multiple nonvolatile memory devices within each optical module can be connected in daisy-chain and controlled, a plurality of optical modules can be controlled cumulatively by a microcomputer, ASIC, or FPGA, while suppressing increase in the number of electric wires.

As a fourth effect, by employing a seal-like RF-ID (TAG) as a nonvolatile memory device in a module structure according to the present invention, there is provided a small optical module that provides easy reflow control, inventory management, and central control of many high density modules.

Namely, since the seal-like RF-ID (TAG) can be installed at any place and removably attachable, removing it temporally makes it possible to avoid a risk that the stored information is erased even when the entire optical module is heated in a reflow and other processes. Since use of wireless communication makes it unnecessary to consider layout of signal wiring, inventory management and central control of many modules are also made easier.

### BRIEF DESCRIPTION OF THE DRAWINGS

FIGS. 1A and 1B are diagrams illustrating a conventional mode for providing users with a small optical module.

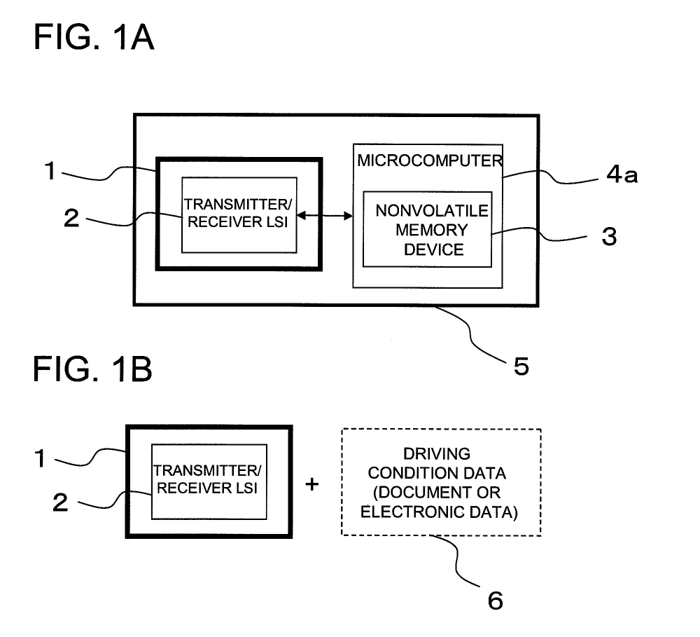

FIG. 2 is a diagram illustrating a conventional mode for providing users with a small optical module.

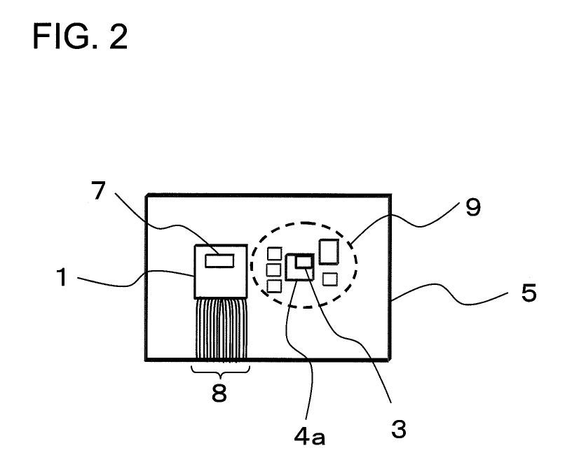

FIG. 3 is block diagram showing a basic structure of an optical module according to a first exemplary embodiment of the present invention.

FIG. 4 is a schematic diagram showing a basic structure of an optical module according to a first exemplary embodiment of the present invention.

FIG. 5 is a diagram illustrating a structure that cumulatively controls a plurality of multiple optical modules according to the present invention.

FIG. 6 is a diagram showing a first example for an optical module according to the present invention.

FIG. 7 is a diagram showing a second example for an optical module according to the present invention.

FIG. 8 is a diagram showing a third example for an optical module according to the present invention.

### EXPLANATIONS OF SYMBOLS

1, 101 (small) optical module
2, 102 transmitter (or receiver) LSI
3, 103 nonvolatile memory device
4a, 4b, 104b, 104c microcomputer
5, 105 board (electronic circuit board)
6 driving condition data (document or electronic data)
7 optical signal emission window
8 high-speed signal line
9, 130 peripheral circuits of a microcomputer
102a transmitter LSI
102b receiver LSI
107 optical signal emission window
108 high-speed signal line
110 flexible electric board
111 light emitting device
112 light receiving device
113 AC coupling capacitor
114 high-speed signal line in a small optical module
115 optical connector pin fitting hole
120 signal line coupled to a ROM

### PREFERRED MODES FOR CARRYING OUT THE INVENTION

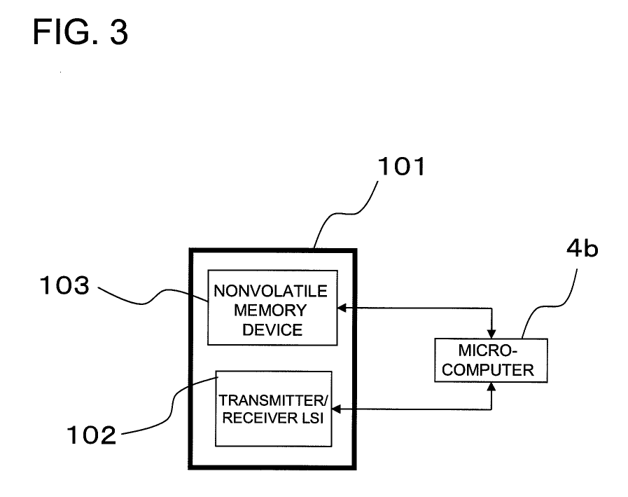

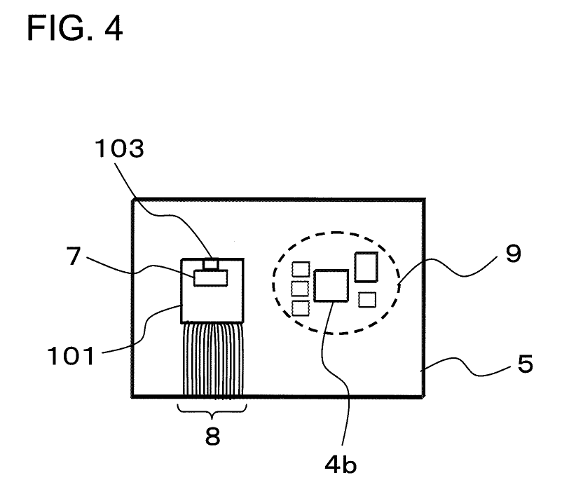

As shown in FIG. 3 and FIG. 4, an optical module 101 according to the present invention comprises a nonvolatile memory device 103 (mask ROM, PROM (Programmable ROM, Fuse-ROM), UV-EPROM, EEPROM (Electrically Erasable PROM), RFID (Tag) and others) or multiple nonvolatile memory devices 103 of different kinds or characters. The nonvolatile memory device 103 includes at least a memory region A that stores basic data that is fixed (determined) at its shipment and inherent to the optical module or a driving condition corresponding to an operation environment or its correction factor table and a memory region B that is rewritten according to an use history (period).

The optical module 101 does not include a microcomputer 4b and its peripheral circuits 9 that read from and write to the nonvolatile memory device 103. The microprocessor 4b may be an operation processing device such as an ASIC or an FPGA and may not include a memory element.

In general, requirement on wiring of a signal line that transmits a driving condition and others (whose clock frequency is at most about 100 MHz) is not higher than that of a high speed signal line 8 (not less than 1 Gbps). Therefore, a set-up position of the nonvolatile memory device 103 may be, for example, at a corner or back side of a board, or top or inside of a metal shield frame or a heat sink or any other places to which a wire can be connected.

Moreover, when an RFID (RF tag) is employed as the nonvolatile memory device 103, the set-up position of the nonvolatile memory device 103 may be on the top surface of a module package and other places to which an electric wire cannot be connected.

Basic data inherent to the optical module 101 (for example, basic data such as a condition to realize an optical signal extinction ratio of 3 dB and an optical output power of 0 dBm in a standard environment under normal temperature, normal humidity and normal pressure, and other manufacturing information. The data is not necessarily a driving condition itself and may be a deviation value from a standard value.) and a driving condition table that corresponds to various environments (or a condition correction factor table) are written into a memory region A housed in the nonvolatile memory device 103 arranged within the optical module 101 at shipment.

A user can read data from the memory region A through a microcomputer 4b (for example, ASIC, FPGA) arranged outside of the optical module 101 (on the same board 5 on which the optical module 101 is arranged or other boards), and read use history information (for example, accumulated use time and others) of the optical module 101 stored in the memory region B at the same time.

The optical module 101 can be driven optimally based on the conditions written into the memory region A and the memory region B. It is preferable that use history information (accumulated use time and others) can be added at any time to the memory region B. The operation environment and the use history information of the optical module 101 may be reflected in the driving condition in the form of a correction factor (coefficient) for the basic data or the driving condition may be selected from stored operation conditions. The correction factor (coefficient) for optimally adopting to an operation environment may be supplied from a vendor of the optical module 101 through the internet or other media or may be derived (taken out) by a user by himself/herself, instead of being written to the optical module 101 at the shipment.

Information stored in the memory region A at the shipment and information added to the memory region B are not limited to the above contents and the need not include all of the above contents.

An optimal (or appropriate) performance of the optical module 101 in any system can be realized by a user based on the information stored in the optical module 101.

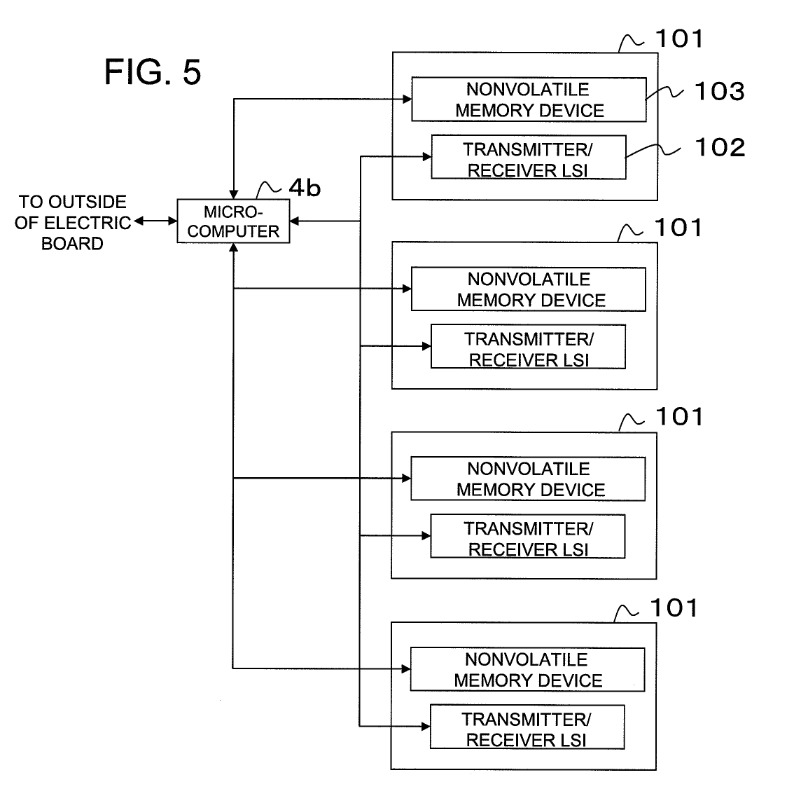

With reference to FIG. 5, if each optical module 101 itself does not store data, a microcomputer 4b (for example, an ASIC or an FPGA) has to store and process data for the many optical modules 101 to manage and cumulatively control the many optical modules. However, according to the structure of the present invention, by storing basic data inherent to each optical module 101 in the nonvolatile memory device 103 of the optical module 101, a burden on the microcomputer 4b that performs the cumulative management and control is eliminated.

### FIRST EXAMPLE

A first example according to the present invention is explained in detail with reference to the drawings.

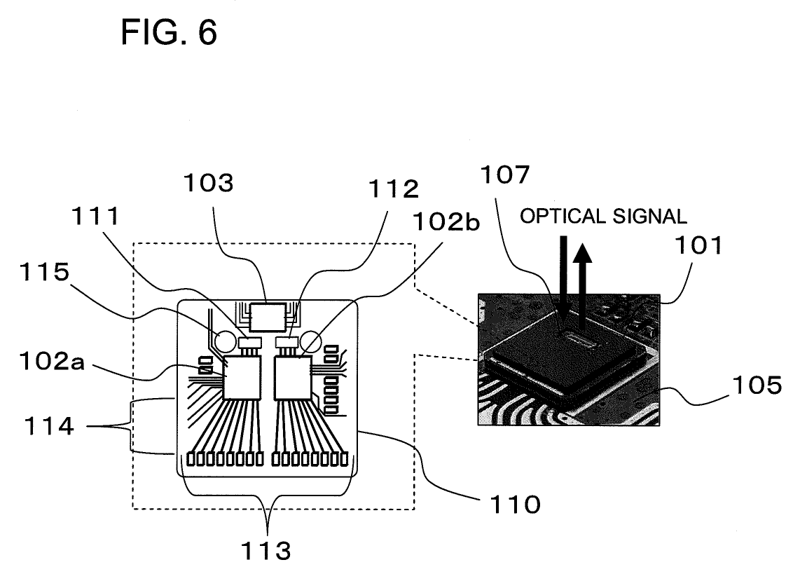

FIG. 6 illustrates a small optical module 101 for optical interconnection.

A light emitting device (LD) 111, a light receiving device (PD) 12, a transmitter LSI (LDD) 102a and a receiver LSI (RCV) 102b are loaded on an interior flexible electric board 110.

This is covered with a metallic electromagnetic shielding frame.

The size of this small optical module 101 is, for example, about 15 millimeters square.

The optical module 101 sends and receives an optical signal to and from an optical fiber through an optical signal emission window 107.

According to the present invention, a nonvolatile memory device 103 that is not included in a conventional optical module is arranged within this small optical module 101. FIG. 6 shows also an AC coupling capacitor 113, high speed signal lines 114 in the small optical module, and optical connector pin fitting holes 115.

The nonvolatile memory device 103 may be any type of nonvolatile memory device such as a mask ROM, PROM (Programmable ROM), fuse-ROM, UV-EPROM, EEPROM, or RFID (RF tag).

Basic data inherent to the optical module 101 (a condition to realize an optical signal extinction ratio of 3 dB and optical output power of 0 dBm in a standard environment under normal temperature, normal humidity and normal pressure, and other manufacturing information. The data is not necessarily a driving condition itself and may be a deviation value from a standard value.) and a driving condition table corresponding to various environments (or condition correction factor table) are stored in a memory region A of the nonvolatile memory device 103 at the shipment.

A user can read data from the memory region A through a microcomputer, ASIC or FPGA arranged outside of the optical module 101 (on the same board 105 on which the optical module 101 is arranged or other boards). Use history information (accumulated use time and others) of the optical module 101 stored in the memory region B is read at the same time. It is possible to drive the optical module 101 optimally (or suitably) based on information written into the memory region A and memory region B. The accumulated use time is written to the memory region B at any time. The operation environment and use history information of the optical module 101 may be reflected in the driving condition as a correction coefficient for the basic data or the driving condition may be selected from stored operation conditions. The correction factor (coefficient) for optimally (suitably) adopting to an operation environment may be provided from a vendor of the optical module 101 through the internet or other media or may be derived originally by a user instead of written to the optical module 101 at the shipment.

Information stored in the memory region A at the shipment and information added to the memory region B are not limited to the above contents and they need not include all of the above contents.

An optimal (or appropriate) performance of the optical module 101 in any system can be realized by a user based on the information stored in the optical module 101.

Requirement on wiring of a signal line that transmits a driving condition and others (whose clock frequency is at most about 100 MHz) is not higher than that of a high speed signal line 114 (not less than 1 Gbps). Therefore, a set-up position of the nonvolatile memory device 103 is not limited to the flexible electric board 110 and may be any places to which a wire can be connected.

A set-up position of the nonvolatile memory device 103 may be, for example, a corner or back side of a board, or top or inside of a metal frame or a heat sink.

Moreover, when an RFID (RF tag) is used as the nonvolatile memory device 103, the set-up position of the nonvolatile memory device 103 may be on the top surface of a module package and other places to which an electric wire cannot be connected.

According to the above optical module structure of the present invention, there is provided an ultrasmall optical module with improved in ease in handling, exchangeability and reparability, while keeping its size.

It is possible to provide users with an optical module which is in an ultrasmall package without a processing element like a microcomputer and its peripheral circuits and without attaching document data on the driving conditions and others. Therefore, the optical module is easy for users to handle.

Replacing an optical module when it breaks down also replaces a driving condition and other information at the same time. Therefore, it is not necessary for users to record information into the optical module.

The module structure of the present invention makes it easy to optimize (or improve) performance of a small optical module in a system, which leads to a longer lifetime and an improved reliability of the module.

By optimally driving a module in each system, a useless operation beyond the system requirement such as excessive output power can also be prevented. Furthermore, correcting a condition according to aging degradation makes it possible to prevent the performance from degradation for a longer period of time.

From vendor's point of view, guaranteeing (storing in a memory device) a standard driving condition and performance (basic data) may meet wide variety of user needs/system requirements, which easily lead to mass production and generalization without a particular specification.

Furthermore, the nonvolatile memory device 103 arranged within an optical module is not limit to one, but there may be two or more nonvolatile memory devices of different kinds or properties.

For example, invariable information such as production date and lot number may be recorded in a mask ROM and information that is replaced at any time, such as driving information and a total use time, may be recorded in a PROM. Storing the same information in multiple ROMs with different interfaces, accessing methods, and environmental tolerances can improve accessibility and the preservation of the stored information.

### SECOND EXAMPLE

In the above example, an optical module itself possesses data such as a driving condition. Therefore, management and control of optical modules as a whole can be made easier.

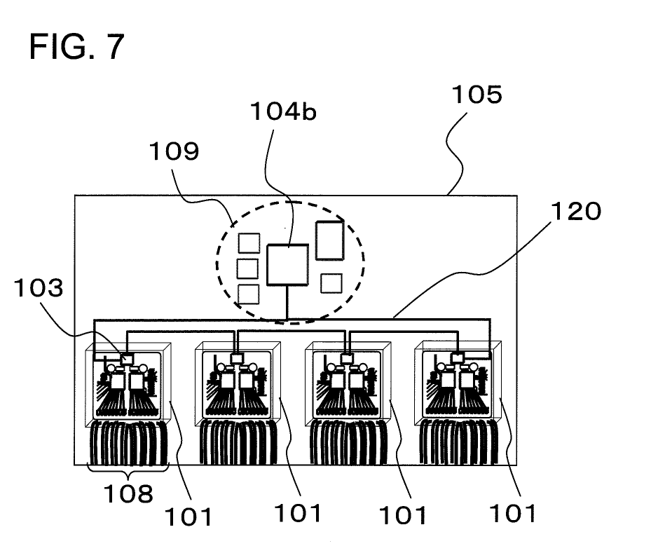

FIG. 7 shows a structure for managing and controlling the optical modules (second example) as a whole.

A single microcomputer 104b (for example, an ASIC or FPGA) is connected to a nonvolatile memory device 103 and a transceiver LSI in small optical modules 101. The microcomputer 104b manages and controls a driving condition and other data. The microcomputer 104b may not have a memory device.

In a case where each optical module 101 itself does not possess data inherent to it as in prior art, the entire data for the many optical modules 101 must be stored and processed at one spot (single CPU, microcomputer, ASIC, FPGA and others). However, since each optical module 101 according to the present example possesses data for itself, a load on a device that performs the cumulative management and control can be reduced.

Effect of reducing the load of the microcomputer 104 becomes more remarkable as the number of managed optical modules 101 increases.

By employing, as the nonvolatile memory device 103, a serial EEPROM that contains a serial interface (I2C or SPI) whose total number of signal pins is less than that for the microcomputer 104b, an area for electrical signal wires to read from and write to the optical module 101 can be reduced.

When multiple nonvolatile memory devices 103 within each optical module 101 can be connected in a daisy-chain fashion and controlled, the whole optical modules can be controlled by a microcomputer 104b (for example, ASIC, FPGA), while suppressing the increase in the number of electric wires.

### THIRD EXAMPLE

By employing a seal-like RFID (TAG) as a nonvolatile memory device 103 in the above second example, there is provided an optical module 101 that provides easy reflow control, inventory management, and central control of many high density modules.

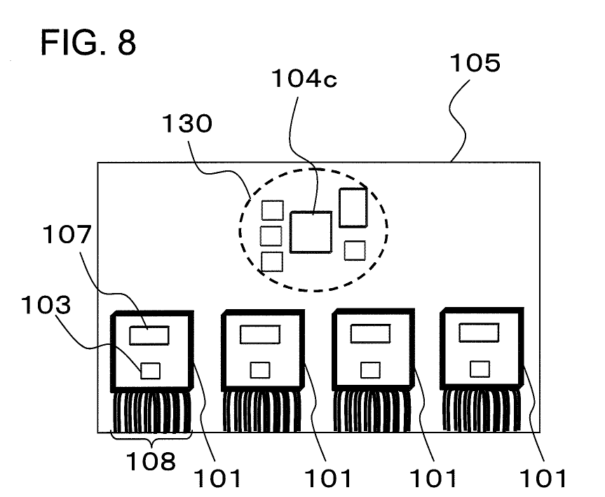

FIG. 8 shows this structure as a third example.

In this case too, a single microcomputer (or an ASIC or FPGA) 104c controls multiple small optical modules 101 in the same way as in the above second example. The microcomputer 104c may be a processing device such as an ASIC or FPGA. The microcomputer 104c, while it includes a circuit for RFID communication, may not include a memory device.

Since wireless communication is employed in the present example, a wire between the nonvolatile memory device 103 and the microprocessor 104c is not necessary. Since it is not necessary to consider layout of the wire, inventory management and central control of many modules are made easier.

FIG. 8 also shows peripheral circuits (buffering IC, resistor, capacitor, feedback loop circuit) of the microcomputer 104c, an optical signal emission window 107, and high-speed signal lines 108.

A seal-like RF-ID (TAG) can be arranged at any places removably attached to it. Therefore, removing the RFID temporally makes it possible to avoid a risk that the stored information is erased even when the whole optical module 101 is heated in a reflow and other processes.

Within the scope of the entire disclosure (including the claims) of the present invention, and based further on the basic technological idea, the preferred modes can be changed and adjusted. Moreover, various combination or selection from the various disclosed elements is possible within the scope of the claims of the present invention.

1. An optical module comprising:
a photoelectric conversion device;
at least one of a transmitter LSI and a receiver LSI;
one or more memory devices; and
an input/output terminal to read and write stored information within the memory device(s);
wherein the memory device(s) further comprises:
a first memory region where a predetermined driving condition for the optical module or manufacturing information and other basic data inherent to the optical module, or a driving condition or its correction factor table is recorded before shipment as an optimum driving condition for the optical module when installed in a system; and
a second memory region where history information such as accumulated use time is recorded after the shipment.

2. The optical module of claim 1, wherein at least one of the memory device(s) is a nonvolatile memory device.

3. The optical module of claim 2, wherein the nonvolatile memory device is a mask ROM.

4. The optical module of claim 2, wherein the nonvolatile memory device is a PROM (Programmable ROM).

5. The optical module of claim 4, wherein the PROM is an EEPROM (Electrically Erasable PROM).

6. The optical module of claim 4, wherein the PROM is an RFID (Radio Frequency ID) or an RF tag.

7. An optical module comprising one or more memory devices, wherein the memory device(s) further comprises:
a first memory region where basic data inherent to the optical module is recorded before shipment; and
a second memory region where history information of the optical module is recorded after the shipment.

8. An optical module comprising:
one or more memory devices,
wherein the memory device(s) further comprises:
a first memory region where a driving condition inherent to the optical module or its correction factor table is recorded before shipment; and
a second memory region where history information of the optical module is recorded after the shipment.

9. The optical module of claim 7, wherein the memory device(s) is a nonvolatile memory device.

10. The optical module of claim 7, wherein the history information includes accumulated use time of the optical module.
